(19) United States
(12) Patent Application Publication
(10) Pub. No.: US 2024/0329571 A1
(43) Pub. Date: Oct. 3, 2024

(54) HEATING SYSTEM AND IMAGE FORMING SYSTEM

(71) Applicant: FUJIFILM Business Innovation Corp., Tokyo (JP)

(72) Inventors: Kosuke YAMADA, Kanagawa (JP); Takayuki YAMASHITA, Kanagawa (JP); Yoshiyuki TOMINAGA, Kanagawa (JP)

(73) Assignee: FUJIFILM Business Innovation Corp., Tokyo (JP)

(21) Appl. No.: 18/461,707

(22) Filed: Sep. 6, 2023

(30) Foreign Application Priority Data
Mar. 27, 2023 (JP) 2023-049916

(51) Int. Cl. G03G 15/20; G03G 15/00; G03G 21/20

(52) U.S. Cl. CPC G03G 15/2007; G03G 15/6529; G03G 15/758; G03G 21/206; G03G 2215/00523

(57) ABSTRACT

A heating system includes a heater compatible with plural heating methods and configured to heat a heating target in a non-contact manner, and one or more processors. The one or more processors are configured to switch a heating method to be used for heating the heating target depending on a material of the heating target.

### CROSS-REFERENCE TO RELATED APPLICATIONS

This application is based on and claims priority under 35 USC 119 from Japanese Patent Application No. 2023-049916 filed Mar. 27, 2023.

### BACKGROUND

### (i) Technical Field

The present disclosure relates to a heating system and an image forming system.

### (ii) Related Art

There is an image forming apparatus that may transfer a toner image onto the surface of a cylindrical object or any other three-dimensional object. The toner image is fixed onto the three-dimensional object by a non-contact heating method. Examples of this type of heating method include an infrared method and a far-infrared method. This heating method is also referred to as “radiation heat method”.

Japanese Patent No. 6900650 is an example of related art.

### SUMMARY

Aspects of non-limiting embodiments of the present disclosure relate to the following circumstances. Examples of the material of the object include metal, ceramic, glass, and cloth. There are heating methods suited to those respective materials. Therefore, heating apparatuses are prepared individually for the materials of the object to be heated. Thus, the heating apparatus subsequent to a transfer apparatus is replaced every time the material is changed, or dedicated lines are prepared individually for the materials.

Aspects of non-limiting embodiments of the present disclosure relate to handling of more material types by a single heating apparatus unlike a case where heating apparatuses are prepared individually for materials.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a heating system comprising: a heater compatible with a plurality of heating methods and configured to heat a heating target in a non-contact manner; and one or more processors, wherein the one or more processors are configured to switch a heating method to be used for heating the heating target depending on a material of the heating target.

### BRIEF DESCRIPTION OF THE DRAWINGS

Exemplary embodiments of the present disclosure will be described in detail based on the following figures, wherein:

FIG. 1 illustrates the overall configuration of an image forming system of a first exemplary embodiment;

FIG. 2 illustrates an example of the configuration of a control panel of the first exemplary embodiment;

FIG. 3 illustrates an example of the configuration of a transfer apparatus of the first exemplary embodiment;

FIGS. 4A and 4B illustrate an example of the configuration of a heating apparatus operating by a far-infrared method, in which FIG. 4A is a front see-through diagram of an internal space and FIG. 4B is a side see-through diagram of the internal space;

FIGS. 5A and 5B illustrate an example of the configuration of the heating apparatus operating by an infrared method, in which FIG. 5A is a front see-through diagram of the internal space and FIG. 5B is a side see-through diagram of the internal space;

FIG. 6 is a table illustrating characteristics of infrared radiation and far-infrared radiation;

FIGS. 7A and 7B illustrate variations in an inter-color temperature difference in a case where a toner image is fixed by the infrared method, in which FIG. 7A illustrates an inter-color temperature difference in a case where the material of a recording medium is aluminum and FIG. 7B illustrates an inter-color temperature difference in a case where the material of the recording medium is ceramic;

FIG. 8 illustrates inter-color temperature differences for individual materials in a case where the heating method is the infrared method;

FIG. 9 illustrates relationships between the materials of the recording medium and absorbed energy;

FIG. 10 illustrates heating periods in a case where the material of the recording medium is aluminum;

FIG. 11 is a flowchart illustrating an example of fixing method switching control to be performed by a processor;

FIG. 12 illustrates the overall configuration of an image forming system of a second exemplary embodiment;

FIG. 13 illustrates an example of the configuration of a heating apparatus;

FIG. 14 is a table illustrating characteristics of infrared radiation, far-infrared radiation, and hot air;

FIG. 15 is a flowchart illustrating another example of the fixing method switching control to be performed by the processor;

FIG. 16 illustrates the overall configuration of an image forming system of a third exemplary embodiment;

FIG. 17 illustrates an example of the configuration of a heating apparatus;

FIG. 18 is a table illustrating characteristics of infrared radiation, far-infrared radiation, and heat;

FIG. 19 is a flowchart illustrating another example of the fixing method switching control to be performed by the processor; and

FIG. 20 illustrates the overall configuration of an image forming system according to another exemplary embodiment.

### DETAILED DESCRIPTION

Exemplary embodiments of the present disclosure are described with reference to the drawings.

### First Exemplary Embodiment

### <System Configuration>

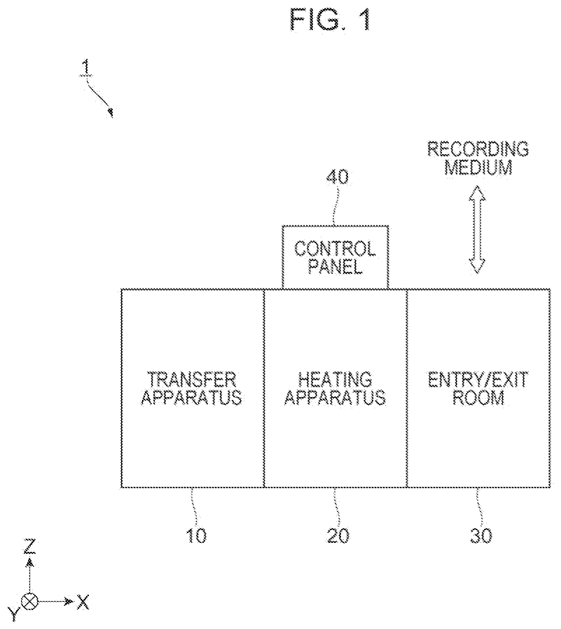

FIG. 1 illustrates the overall configuration of an image forming system 1 of a first exemplary embodiment.

In FIG. 1, the image forming system 1 includes a transfer apparatus 10 that transfers a toner image onto a recording medium, a heating apparatus 20 that fixes the transferred toner image onto the recording medium, an entry/exit room 30, and a control panel 40.

Examples of the recording medium of this exemplary embodiment include a plate-shaped member made of a metal (hereinafter referred to as “metal plate”), a metal can, ceramics, and a glass. The recording medium is an example of a heating target. Examples of the metal can include an aluminum can and a steel can. The ceramics refer to objects made of a ceramic, and examples thereof include a tile.

The recording medium of this exemplary embodiment may have a planar or three-dimensional shape. In this exemplary embodiment, the planar shape corresponds to such an object that the maximum value of the thickness (i.e., a height in a Z-axis direction) is equal to or smaller than a reference value, and the three-dimensional shape corresponds to such an object that the maximum value of the thickness is larger than the reference value. Examples of the three-dimensional shape include a cylinder, a column, a box, a sphere, and a polyhedron.

In this exemplary embodiment, the transfer apparatus 10, the heating apparatus 20, the entry/exit room 30, and the control panel 40 have independent casings.

In this exemplary embodiment, the casings of the transfer apparatus 10, the heating apparatus 20, and the entry/exit room 30 are connected to each other. The transfer apparatus 10, the heating apparatus 20, and the entry/exit room 30 may be housed in a single casing to apparently constitute a single apparatus.

The internal space of the transfer apparatus 10 and the internal space of the heating apparatus 20 are connected to each other through openings on the sides of the casings. Similarly, the internal space of the heating apparatus 20 and the internal space of the entry/exit room 30 are connected to each other through openings on the sides of the casings. That is, the internal space of the transfer apparatus 10, the internal space of the heating apparatus 20, and the internal space of the entry/exit room 30 are connected to each other to constitute a single internal space. The connected internal spaces are hereinafter referred to as “internal space of image forming system 1”.

In the internal space of the image forming system 1, a transport rail (not illustrated) is attached across the transfer apparatus 10, the heating apparatus 20, and the entry/exit room 30. The recording medium is transported along the transport rail.

A plane that appears in FIG. 1 is referred to as “front”. A plane that is opposite to the front and does not appear in FIG. 1 is referred to as “back”. A YZ plane in FIG. 1 is referred to as “side”. In FIG. 1, the Z-axis direction is referred to as “height”, and the transport of the recording medium in the Z-axis direction is referred to as “ascend/descend”. The transport in an X-axis direction is referred to as “horizontal movement”. A plane defined by an X axis and a Y axis is parallel to a floor.

The transfer apparatus 10 transfers, onto the recording medium, an image (hereinafter referred to as “toner image”) formed with toner or powdery particles (hereinafter referred to also as “toner etc.”). That is, the transfer apparatus 10 of this exemplary embodiment transfers the image by an electrophotographic system.

The heating apparatus 20 fixes the toner image onto the surface of the recording medium by a non-contact heating method. The heating apparatus 20 of this exemplary embodiment has two types of fixing method, and may switch the fixing methods depending on the material of the recording medium. In other words, the heating apparatus 20 has two types of heating method, and may switch the heating methods depending on the recording medium.

One of the fixing methods is a method using far-infrared rays (FIR). The other of the fixing methods is a method using infrared rays (IR). The fixing methods are switched under control of the control panel 40.

In each method, the toner image is fixed onto the surface of the recording medium by melting the transferred toner with radiation heat. Both the far-infrared method and the infrared method are categorized into the non-contact methods.

The heating apparatus 20 is an example of a heater.

The entry/exit room 30 is a box-shaped casing for the recording medium to enter and exit the image forming system 1. In FIG. 1, the entry/exit room 30 has an opening on its top for entry and exit of the recording medium. The recording medium that has entered from the entry/exit room 30 is transported to the transfer apparatus 10 through the heating apparatus 20. When the recording medium is transported to a transfer start position, the transfer apparatus 10 starts to transfer a toner image. When the toner image has been transferred onto the recording medium, the recording medium is transported from the transfer apparatus 10 to the heating apparatus 20. The heating apparatus 20 heats, for a preset period, the recording medium onto which the toner image has been transferred to fix the toner image onto the recording medium. The recording medium onto which the toner image has been fixed is transported from the heating apparatus 20 to the entry/exit room 30, and then exits to an external space.

The control panel 40 is a computer that controls a printing operation of the image forming system 1.

In FIG. 1, the control panel 40 is attached to the top of the casing of the heating apparatus 20.

The control panel 40 may be attached at any position. For example, the control panel 40 may be attached to the top of the transfer apparatus 10 or the entry/exit room 30. The control panel 40 may be integrated with the transfer apparatus 10 or the like.

In this exemplary embodiment, a system including the heating apparatus 20 and a functional part of the control panel 40 that switches the fixing method of the heating apparatus 20 is referred to as “heating system”. If the heating apparatus 20 performs the fixing method switching control alone, the heating apparatus 20 is referred to as “heating system”.

The control panel 40 may be connected communicably to the transfer apparatus 10, the heating apparatus 20, and the like via a communication line or a network. The network may be a local area network (LAN), the Internet, a cloud network, or a mobile communication system.

### <Configuration of Control Panel>

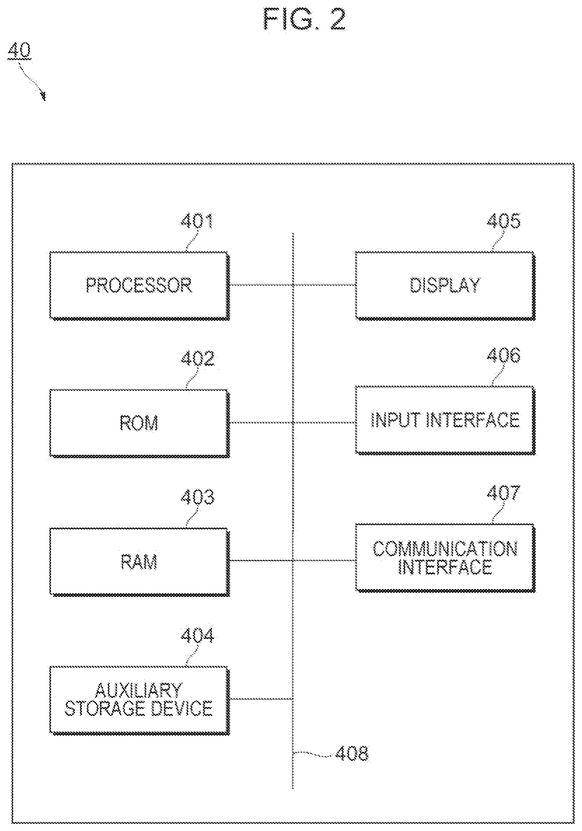

FIG. 2 illustrates an example of the configuration of the control panel 40 of the first exemplary embodiment. In FIG. 2, the control panel 40 includes a processor 401, a read only memory (ROM) 402 that stores a basic input/output system (BIOS) and the like, a random access memory (RAM) 403 serving as a working area for the processor 401, an auxiliary storage device 404, a display 405, an input interface 406, and a communication interface 407. The devices are connected via a bus or other signal lines 408.

The processor 401 is a device that implements various functions by executing programs. The processor 401, the ROM 402, and the RAM 403 function as the computer.

The auxiliary storage device 404 includes, for example, a hard disk drive or a semiconductor storage. The auxiliary storage device 404 stores various types of data on programs. The programs include an OS and application programs.

Examples of the display 405 include a liquid crystal display and an organic electroluminescent (EL) display. The display 405 may be integrated with the control panel 40, provided externally to the control panel 40, or connected by wireless communication.

The input interface 406 receives information from a keyboard, a mouse, and other input devices.

The communication interface 407 is used for communication with, for example, the transfer apparatus 10 (see FIG. 1), the heating apparatus 20 (see FIG. 1), and the entry/exit room 30 (see FIG. 1). The communication interface 407 is compatible with various communication standards in conjunction with signal lines and networks for communication. Examples of the communication standards include a peripheral component interconnect (PCI) bus, a peripheral component interconnect-express (PCIe) bus, and Ethernet (registered trademark).

### <Configuration of Transfer Apparatus>

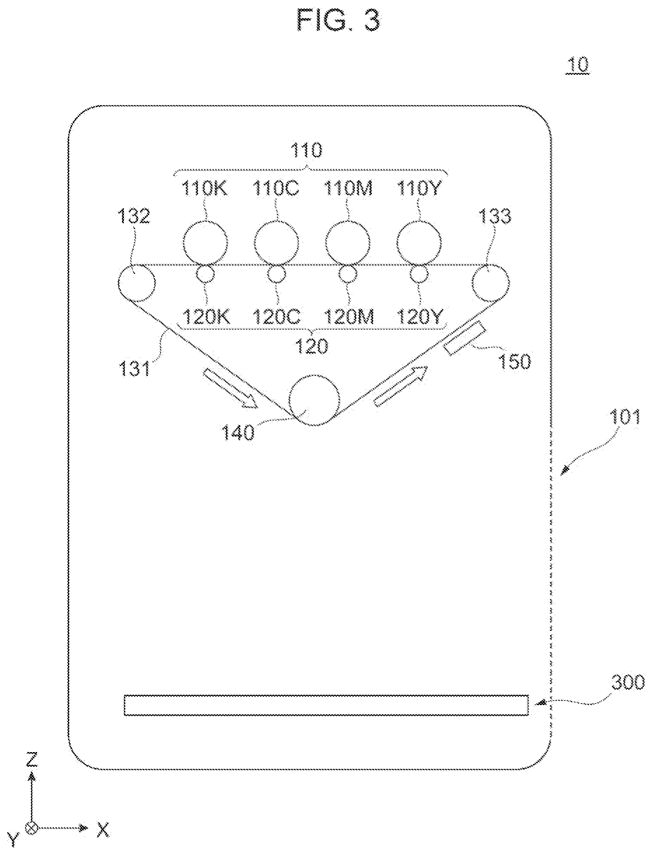

FIG. 3 illustrates an example of the configuration of the transfer apparatus 10 of the first exemplary embodiment.

The transfer apparatus 10 has an opening 101 on the side of the casing for connection to the internal space of the heating apparatus 20.

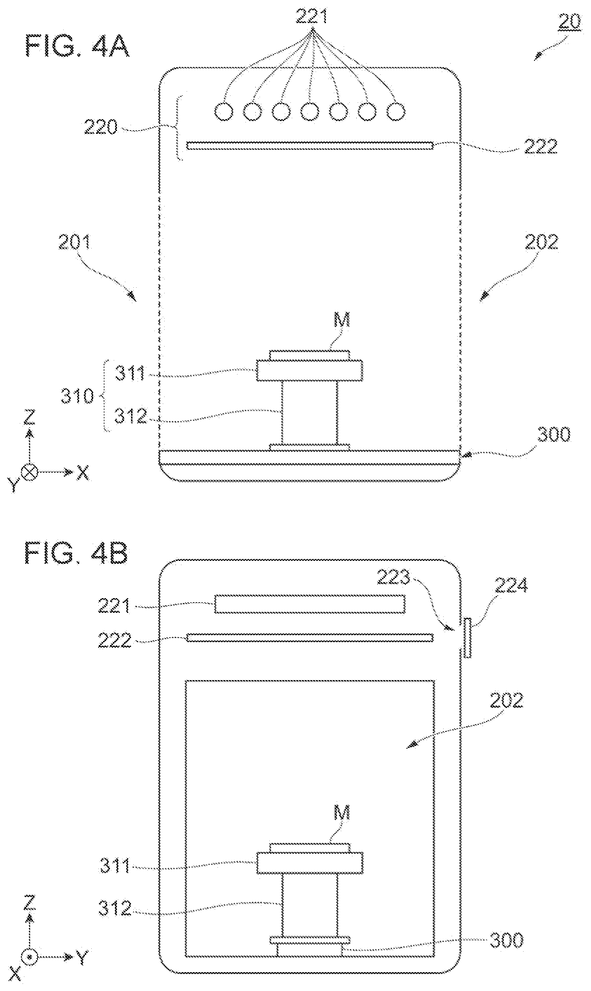

A transport rail 300 is attached to the bottom of the transfer apparatus 10 to transport a transport mechanism 310 described later (see FIGS. 4A and 4B).

A developing device 110, a first transfer roller 120, and an intermediate transfer belt 131 are provided in an upper space of the transfer apparatus 10. The intermediate transfer belt 131 cyclically moves while being looped around drive rollers 132 and 133 and a backup roller 140. The intermediate transfer belt 131 is an example of a transfer belt.

The transfer apparatus 10 includes a cleaning device 150 that removes, from the intermediate transfer belt 131, toner particles remaining on the intermediate transfer belt 131 after passing through a transfer position.

The developing device 110 is a unit that forms an electrostatic latent image of a target image on a photoconductor and causes charged toner particles to adhere to the electrostatic latent image on the photoconductor to develop a toner image. In FIG. 3, the developing device 110 includes subunits for yellow, magenta, cyan, and black.

In FIG. 3, the yellow, magenta, cyan, and black subunits are represented by symbols “Y”, “M”, “C”, and “K” indicating the respective colors.

The first transfer roller 120 is used for transferring the image formed by the developing device 110 onto the intermediate transfer belt 131. The transfer performed by the first transfer roller 120 is referred to as “first transfer”.

The first transfer roller 120 faces the developing device 110 across the intermediate transfer belt 131, and brings the outer peripheral surface of the intermediate transfer belt 131 into contact with the developing device 110.

The first transfer roller 120 is provided for each of developing devices 110Y, 110M. 110C, and 110K. In FIG. 3, the first transfer rollers 120 corresponding to the individual colors are represented by “120Y”, “120M”, “120C”, and “120K”.

In FIG. 3, the intermediate transfer belt 131 moves in an arrow direction (i.e., counterclockwise). The intermediate transfer belt 131 is moved by, for example, either one or both of the drive rollers 132 and 133.

In FIG. 3, toner images are firstly transferred onto the outer peripheral surface of the intermediate transfer belt 131. That is, the intermediate transfer belt 131 carries toner images corresponding to the individual colors. The outer peripheral surface of the intermediate transfer belt 131 is hereinafter referred to as “transfer surface”.

In the configuration illustrated in FIG. 3, yellow, magenta, cyan, and black layers are stacked in this order from the bottom on the transfer surface of the intermediate transfer belt 131. That is, the transfer surface carries a multicolor toner image.

The backup roller 140 brings the transfer surface of the intermediate transfer belt 131 into contact with the recording medium to transfer the toner image carried by the transfer surface onto the surface of the recording medium. The transfer performed by the backup roller 140 is referred to as “second transfer”.

In the second transfer, a predetermined voltage is applied to the backup roller 140. Through the voltage application, an electric field (hereinafter referred to as “transfer field”) is generated between the backup roller 140 and the recording medium, and the toner image formed by using charged toner is transferred onto the surface of the recording medium.

Thus, a current flows from the backup roller 140 to the recording medium via the intermediate transfer belt 131 to transfer the image from the intermediate transfer belt 131 to the recording medium.

In a case where the recording medium is a non-conductor, a conductive layer is formed on the recording medium in advance to secure a current path.

The cleaning device 150 is provided between the transfer position and the developing device 110Y on its downstream side. In other words, the cleaning device 150 is provided on a downstream side of the transfer position and on an upstream side of the developing device 110Y.

The cleaning device 150 removes residual toner to prepare for the next transfer cycle. That is, a new toner image may be transferred onto the transfer surface.

### <Configuration of Heating Apparatus>

FIGS. 4A and 4B illustrate an example of the configuration of the heating apparatus 20 operating by the far-infrared method. FIG. 4A is a front see-through diagram of the internal space. FIG. 4B is a side see-through diagram of the internal space.

The heating apparatus 20 has an opening 201 on the side for connection to the internal space of the transfer apparatus 10, and has an opening 202 on the side for connection to the entry/exit room 30.

A light source unit 220 is disposed in an upper space of the heating apparatus 20 to output far-infrared rays. The light source unit 220 is an example of a light source in a broad sense. The light source unit 220 may be an example of a heat source.

The light source unit 220 includes a plurality of infrared radiation lamps 221 and a black plate 222. Each infrared radiation lamp 221 is the light source in a narrow sense. The infrared radiation lamp 221 is also referred to as “infrared light source”.

The black plate 222 absorbs infrared rays and emits far-infrared rays. The black plate 222 is made of, for example, a ceramic. The black plate 222 combined with the infrared radiation lamp 221 is the light source in a broad sense.

The black plate 222 is insertable into and removable from the internal space by a drive mechanism (not illustrated). In FIG. 4B, the black plate 222 is linearly inserted into and removed from the internal space by the drive mechanism. The black plate 222 is movably attached to a rail (not illustrated), and the position of the black plate 222 is changed by using a motor (not illustrated) as a power source.

As illustrated in FIG. 4B, the heating apparatus 20 has a window 223 on the back for insertion and removal of the black plate 222. In FIGS. 4A and 4B, the fixing is performed by the far-infrared method. Therefore, the black plate 222 is positioned below the infrared radiation lamps 221. That is, the black plate 222 is positioned on a radiation path of infrared rays. The window 223 is closed by a door 224. The window 223 is opened and closed by the door 224 by sliding the door 224 along the casing surface or turning the door 224 about a turn axis on the casing surface.

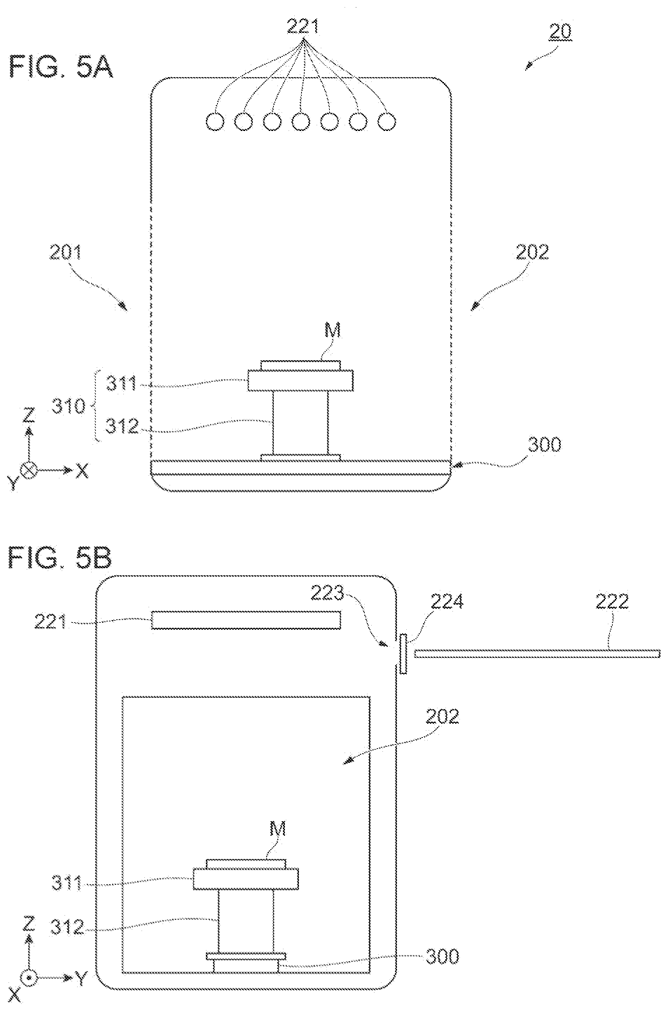

FIGS. 5A and 5B illustrate an example of the configuration of the heating apparatus 20 operating by the infrared method. FIG. 5A is a front see-through diagram of the internal space. FIG. 5B is a side see-through diagram of the internal space. In FIGS. 5A and 5B, parts corresponding to those in FIGS. 4A and 4B are represented by corresponding symbols.

In FIGS. 5A and 5B, the heating apparatus 20 operates by the infrared method. Therefore, the black plate 222 is not illustrated below the infrared radiation lamps 221 in FIG. 5A. In FIG. 5B, the black plate 222 is pulled out through the window 223 on the back. In FIG. 5B, the door 224 closes the window 223 after the black plate 222 has been pulled out.

In FIGS. 5A and 5B, infrared rays are radiated onto a recording medium M because the black plate 222 is not positioned on the radiation path of infrared rays.

The heating apparatus 20 has the opening 201 on the side for connection to the internal space of the transfer apparatus 10, and has the opening 202 on the side for connection to the entry/exit room 30.

The transport rail 300 is attached between the openings 201 and 202. The transport mechanism 310 is attached to the transport rail 300 to transport the recording medium M.

In FIGS. 4A and 4B and FIGS. 5A and 5B, the transport mechanism 310 includes a transport stage 311 and a lift mechanism 312. The upper end of the lift mechanism 312 is attached to the bottom surface of the transport stage 311. The lower end of the lift mechanism 312 is attached so that the lift mechanism 312 is movable along the transport rail 300 (i.e., horizontally movable).

The lift mechanism 312 is horizontally moved, for example, by a self-traveling mechanism provided to the lift mechanism 312 or by traction using a motor or any other drive mechanism provided to the transport rail 300.

The lift mechanism 312 lifts the transport stage 311 manually or under control of the processor 401 (see FIG. 2).

The recording medium M may be attached to the top surface of the transport stage 311 (hereinafter referred to as “attachment surface”) directly or with a jig (not illustrated). The jig may be attached to or detached from the attachment surface of the transport stage 311.

### <Characteristics of Far-Infrared Method and Infrared Method>

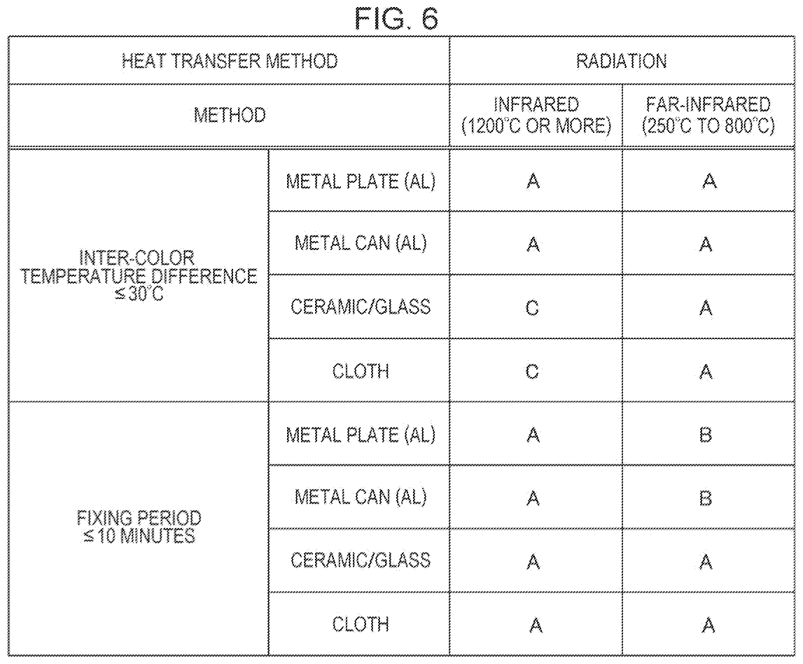

FIG. 6 is a table illustrating characteristics of infrared radiation and far-infrared radiation.

In FIG. 6, evaluation results for individual materials are expressed in three levels from the viewpoint of an inter-color temperature difference and a fixing period. Specifically, the highest evaluation level is “A”, the lowest evaluation level is “C”, and the medium evaluation level is “B”.

The “inter-color temperature difference” is a difference between a temperature of the recording medium M at a part where black toner is transferred and a temperature of the recording medium M at a part where the toner is not transferred.

In a case where the material of the recording medium M is aluminum, the evaluation of the inter-color temperature difference is “A” both in the fixing by the infrared method and in the fixing by the far-infrared method.

In a case where the material of the recording medium M is ceramic, glass, or cloth, the evaluation of the inter-color temperature difference is “A” in the fixing by the far-infrared method, and is “C” in the fixing by the infrared method.

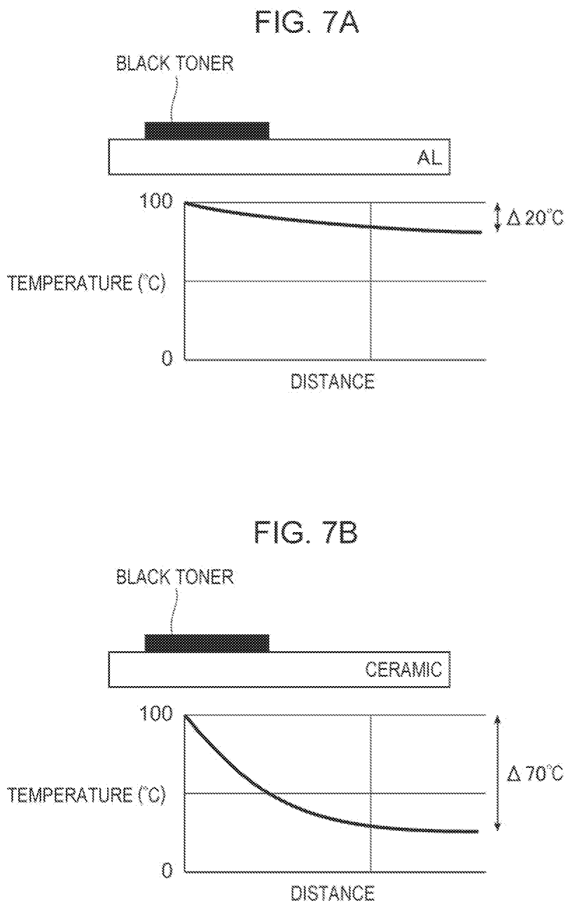

FIGS. 7A and 7B illustrate variations in the inter-color temperature difference in a case where the toner image is fixed by the infrared method. FIG. 7A illustrates the inter-color temperature difference in the case where the material of the recording medium M is aluminum. FIG. 7B illustrates the inter-color temperature difference in the case where the material of the recording medium M is ceramic.

In FIGS. 7A and 7B, a relationship between a sectional structure of the recording medium M and a temperature change depending on a distance from the black toner is represented by a curve. In FIGS. 7A and 7B, the temperature of the part where the black toner is transferred is about 100° C. higher than the melting temperature of the black toner. The melting temperature of the black toner varies depending on its composition.

A temperature difference occurs between the part where the black toner is transferred and the part where the black toner is not transferred due to a difference in energy based on the heat absorption amount. This temperature difference is referred to as “inter-color temperature difference”.

Metal has high thermal conductivity. When the material of the recording medium M is a metal (aluminum in FIGS. 7A and 7B), the heat of the part where the black toner is transferred easily propagates to the part where the black toner is not transferred. In the case where the material of the recording medium M is a metal, the inter-color temperature difference is smaller than those of other materials having low thermal conductivity. In FIG. 7A, the inter-color temperature difference is 20° C.

Glass, ceramic, or the like has lower thermal conductivity than metal. In FIG. 7B, the inter-color temperature difference is 70° C. that is larger than a permissible temperature difference of 30° C. Therefore, the evaluation result is “C” in FIG. 6.

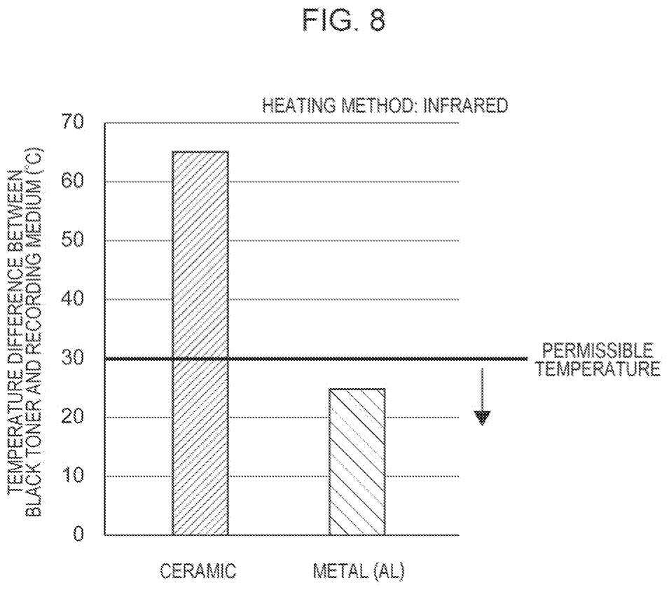

FIG. 8 illustrates inter-color temperature differences for individual materials in a case where the heating method is the infrared method. The vertical axis represents the temperature difference in units of “° C.”.

In FIG. 8, the inter-color temperature difference of ceramic is 65° C., and the inter-color temperature difference of aluminum is 25° C. In FIG. 8, the permissible temperature is 30° C. From the viewpoint of the inter-color temperature difference, it is not desirable to heat a ceramic recording medium M with infrared rays.

The far-infrared heating temperature is lower than the infrared heating temperature. In the case of the far-infrared method, the inter-color temperature difference is smaller than the inter-color temperature difference illustrated in FIG. 8. Therefore, far-infrared rays may be used for heating a metal recording medium M.

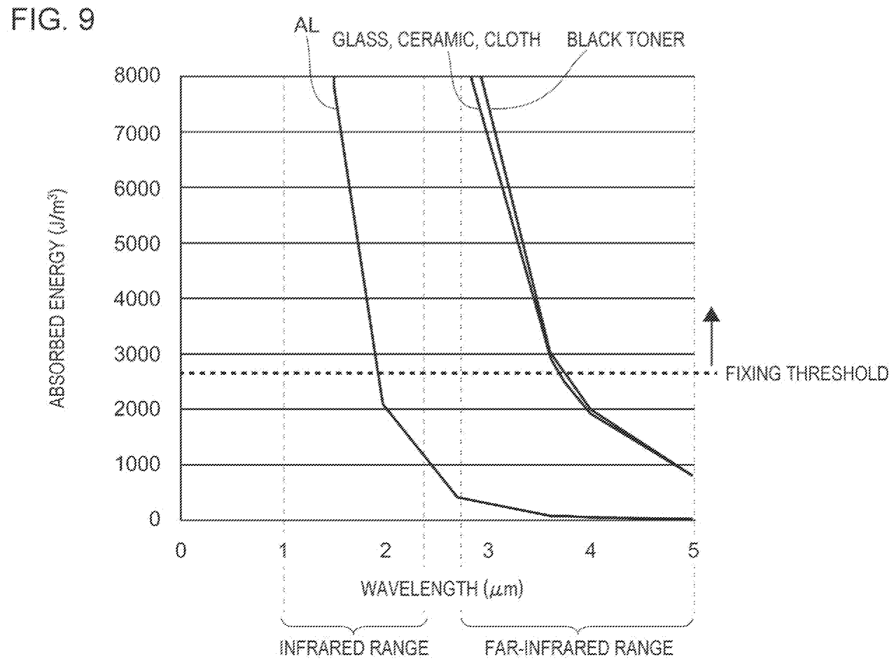

FIG. 9 illustrates relationships between the materials of the recording medium M and absorbed energy. The vertical axis represents the absorbed energy. The horizontal axis represents a wavelength.

The absorbed energy is calculated by “absorptance×light energy”. The light energy increases as the wavelength decreases. Thus, the light energy of infrared rays is larger than the light energy of far-infrared rays. The lower limit value of the absorbed energy for the fixing of the black toner (hereinafter referred to as “fixing threshold”) is about 2700 J/m³.

The absorbed energy of metal is smaller than the fixing threshold in the entire far-infrared range (about 2.5 μm or more in FIG. 9). Since the absorbed energy is smaller than the fixing threshold, it takes a long period to increase the temperature of the metal to the fixing temperature of the black toner.

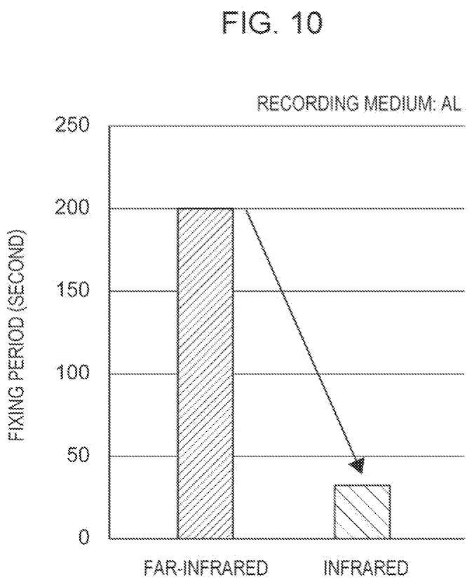

FIG. 10 illustrates heating periods in the case where the material of the recording medium M is aluminum. The vertical axis represents the fixing period in units of second. In FIG. 10, it takes about 200 seconds for the fixing using far-infrared rays. This period depends on the shape and size of the recording medium M.

In an infrared range (less than about 2.5 μm in FIG. 9), the absorbed energy of the metal is larger than the fixing threshold at a wavelength of 2 μm or less. When the absorbed energy is larger than the fixing threshold, it takes a shorter period to increase the temperature of the metal to the fixing temperature of the black toner. In FIG. 10, the fixing period is 30 seconds. Regarding the metal, it takes a shorter fixing period to fix the toner image when infrared rays are used.

As illustrated in FIG. 9, the absorbed energies of the black toner, glass, and the like change substantially similarly irrespective of the wavelength of the light source.

Although illustration is omitted in FIG. 9 for the absorbed energies of the black toner, glass, and the like in the infrared range, the absorbed energies are larger than those in the far-infrared range.

Therefore, the fixing period is shorter in the case where infrared rays are used for fixing the toner image transferred onto glass or the like than in the case where far-infrared rays are used. However, the inter-color temperature difference exceeds the permissible temperature when the infrared method is used for the fixing to the glass, ceramic, or the like as described above. Thus, the far-infrared method is the only candidate for the heating of the glass or ceramic recording medium M.

In the case where far-infrared rays are used for fixing the toner image transferred onto metal, the fixing period is longer than in the case where infrared rays are used as illustrated in FIG. 10.

Therefore, the infrared method in which the inter-color temperature difference is addressed and the fixing period is short is used for fixing the toner image transferred onto the metal.

### <Fixing Method Switching Control>

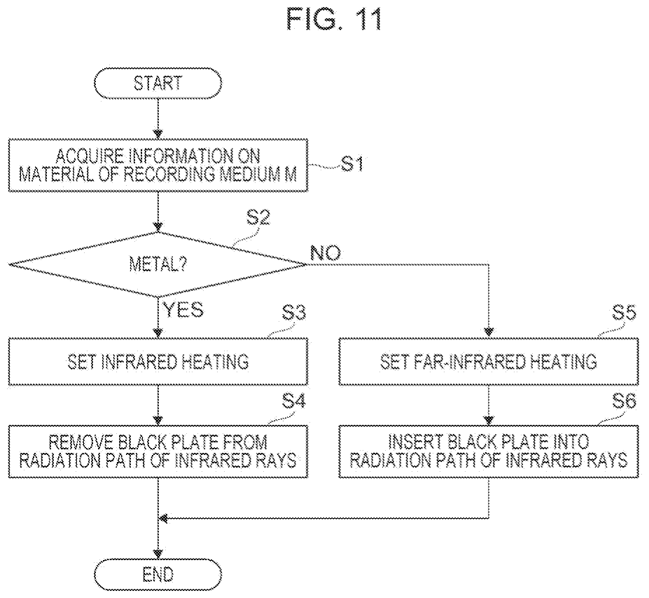

FIG. 11 is a flowchart illustrating an example of the fixing method switching control to be performed by the processor 401 (see FIG. 2). In FIG. 11, the symbol “S” means “step”.

In FIG. 11, the processing operation is performed before the start of the first fixing of the toner image at the latest. In this exemplary embodiment, the processing operation illustrated in FIG. 11 is performed after the image forming system 1 has set the type of the recording medium M.

The processor 401 acquires information on the material of the recording medium M (Step 1). A user who operates the image forming system 1 (see FIG. 1) inputs the information on the material of the recording medium M. In this exemplary embodiment, the material of the recording medium M is selected from among metal, glass, ceramic, and cloth. Examples of the method for inputting the information on the material of the recording medium M include a method involving inputting the name of the material and a method involving selecting an option associated with the material.

When the information on the material of the recording medium M is acquired, the processor 401 determines whether the material is metal (Step 2).

If the material is metal, the result is “YES” in Step 2. In this case, the processor 401 sets infrared heating (Step 3) and removes the black plate 222 from the radiation path of infrared rays (Step 4). In this exemplary embodiment, the black plate 222 is moved out through the window 223 (see FIGS. 5A and 5B) on the back of the heating apparatus 20 (see FIGS. 5A and 5B).

If the material is glass, ceramic, or cloth, the result is “NO” in Step 2. In this case, the processor 401 sets far-infrared heating (Step 5) and inserts the black plate 222 into the radiation path of infrared rays (Step 6).

### BRIEF SUMMARY

As described above, the heating apparatus 20 (see FIG. 1) of the image forming system 1 (see FIG. 1) of this exemplary embodiment is configured to insert the black plate 222 (see FIGS. 5A and 5B) into and remove the black plate 222 from the radiation path of infrared rays.

For example, the infrared method is used for fixing the toner image onto the recording medium M made of aluminum or other metals, and the far-infrared method is used for fixing the toner image onto the recording medium M made of a material other than metals.

### Second Exemplary Embodiment

In a second exemplary embodiment, three types of heating method are switched depending on the material of the recording medium M.

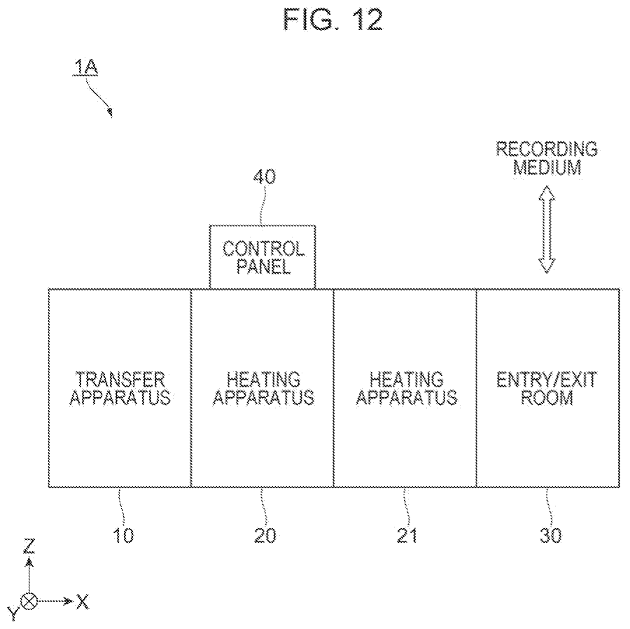

FIG. 12 illustrates the overall configuration of an image forming system 1A of the second exemplary embodiment. In FIG. 12, parts corresponding to those in FIG. 1 are represented by corresponding symbols.

In FIG. 12, the image forming system 1A includes a transfer apparatus 10 that transfers a toner image onto a recording medium M, heating apparatuses 20 and 21 that fix the transferred toner image onto the recording medium M, an entry/exit room 30, and a control panel 40.

The heating apparatus 20 is the same as the heating apparatus of the first exemplary embodiment. That is, the heating apparatus 20 fixes the toner image by the infrared method or the far-infrared method.

The heating apparatus 21 fixes the toner image by hot air at, for example, 200° C. or more.

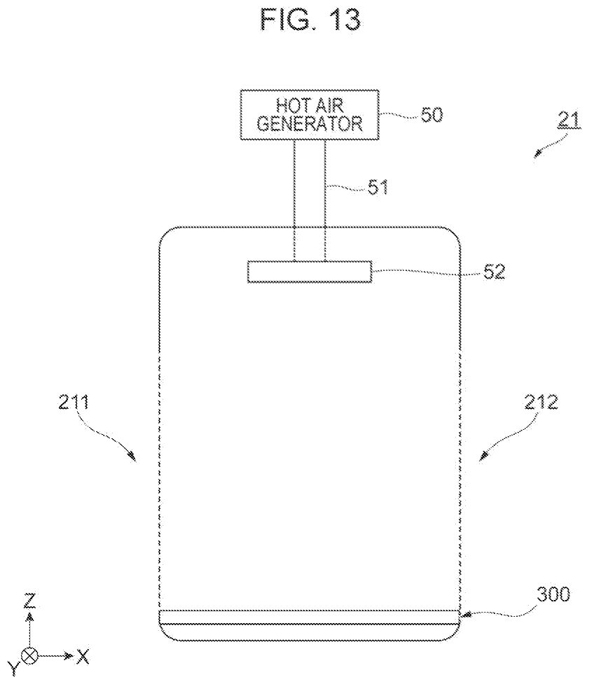

FIG. 13 illustrates an example of the configuration of the heating apparatus 21. In FIG. 13, parts corresponding to those in FIGS. 4A and 4B are represented by corresponding symbols.

The heating apparatus 21 has an opening 211 on the side for connection to the internal space of the heating apparatus 20, and has an opening 212 on the side for connection to the entry/exit room 30. A transport rail 300 is attached between the openings 211 and 212.

This exemplary embodiment is different from the first exemplary embodiment in that the opening 202 of the heating apparatus 20 is connected to the internal space of the heating apparatus 21.

The heating apparatus 21 has a hot air outlet 52 in its upper space. One end of a duct 51 is connected to the outlet 52, and hot air generated by a hot air generator 50 is supplied to the outlet 52. The hot air generator 50 generates hot air when hot air heating is set to heat the recording medium M positioned in the internal space of the heating apparatus 21. The hot air generator 50 is an example of the heat source.

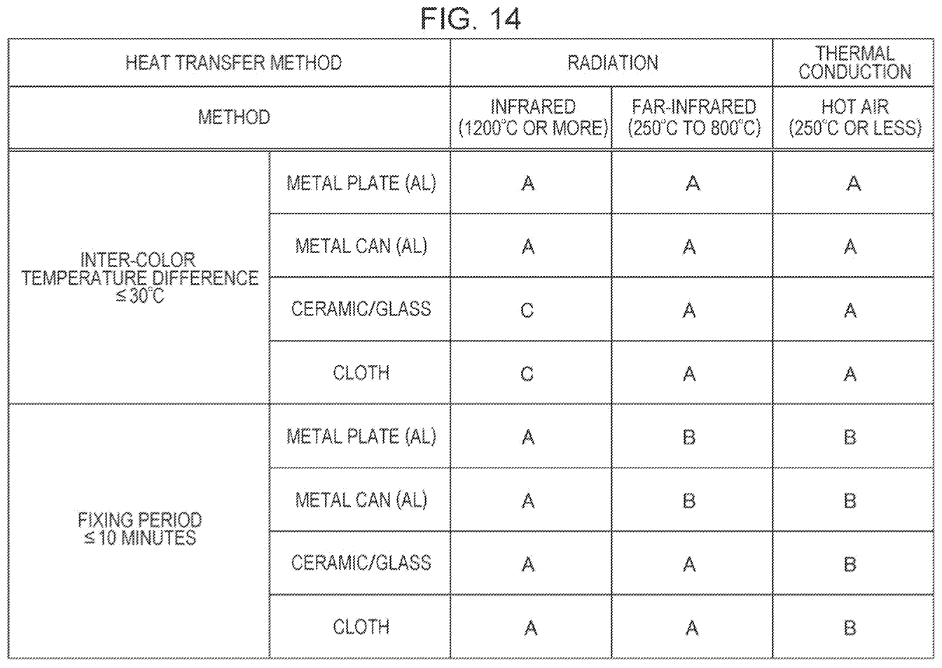

FIG. 14 is a table illustrating characteristics of infrared radiation, far-infrared radiation, and hot air. The characteristics of the infrared radiation and the far-infrared radiation are the same as those in the first exemplary embodiment, and description thereof is therefore omitted.

The temperature of hot air is lower than that of far-infrared rays. Therefore, the inter-color temperature difference substantially does not occur. Thus, the evaluation result for each individual material is the highest evaluation level “A”. Although the evaluation result is the same as that of the far-infrared rays, the inter-color temperature difference is smaller in the case where the hot air is used for fixing the toner image.

As described above, the temperature of the hot air is approximately equal to or lower than that of the far-infrared rays. Therefore, the evaluation result of the fixing period is the medium evaluation level “B”.

In this exemplary embodiment, the hot air is used for fixing the toner image onto a heat-sensitive cloth, and the same selection as in the first exemplary embodiment is made for the other materials.

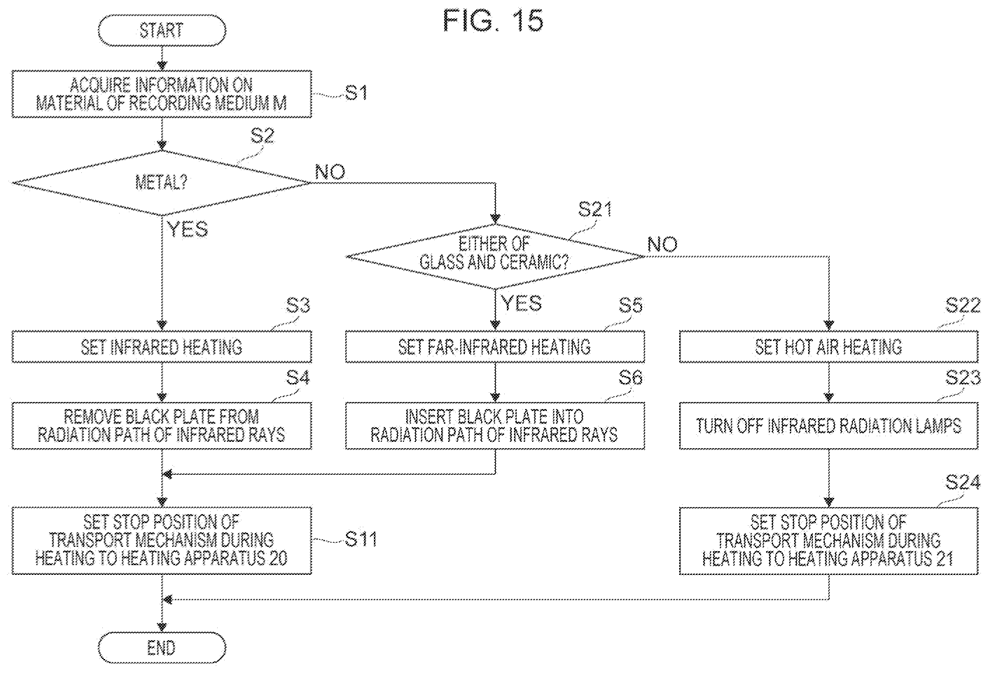

FIG. 15 is a flowchart illustrating another example of the fixing method switching control to be performed by the processor 401 (see FIG. 2). In FIG. 15, parts corresponding to those in FIG. 11 are represented by corresponding symbols.

The processor 401 acquires information on the material of the recording medium M (Step 1).

When the information on the material of the recording medium M is acquired, the processor 401 determines whether the material is metal (Step 2).

If the material is metal, the result is “YES” in Step 2. In this case, the processor 401 sets the infrared heating (Step 3) and removes the black plate 222 from the radiation path of infrared rays (Step 4).

The processor 401 sets the stop position of the transport mechanism 310 during the heating to the heating apparatus 20 (Step 11). This is because the two heating spaces are provided in this exemplary embodiment.

If the material is glass, ceramic, or cloth, the result is “NO” in Step 2. In this case, the processor 401 determines whether the material is “either of glass and ceramic” (Step 21).

If the material of the recording medium M is either of glass and ceramic, the result is “YES” in Step 21. In this case, the processor 401 sets the far-infrared heating (Step 5) and inserts the black plate 222 into the radiation path of infrared rays (Step 6). Then, the processor 401 sets the stop position of the transport mechanism 310 during the heating to the heating apparatus 20 (Step 11).

If the material is cloth, the result is “NO” in Step 21. In this case, the processor 401 sets the hot air heating (Step 22). The processor 401 turns off the infrared radiation lamps 221 (see FIGS. 4A and 4B) (Step 23). Then, the processor 401 sets the stop position of the transport mechanism 310 during the heating to the heating apparatus 21 (Step 24).

### BRIEF SUMMARY

As described above, the image forming system 1A of this exemplary embodiment includes the heating apparatus 20 (see FIG. 12) configured to switch the two types of heating method, and the heating apparatus 21 (see FIG. 12) configured to perform the hot air heating.

### Third Exemplary Embodiment

In a third exemplary embodiment, description is made about another apparatus configuration in which three types of heating method are switched depending on the material of the recording medium M.

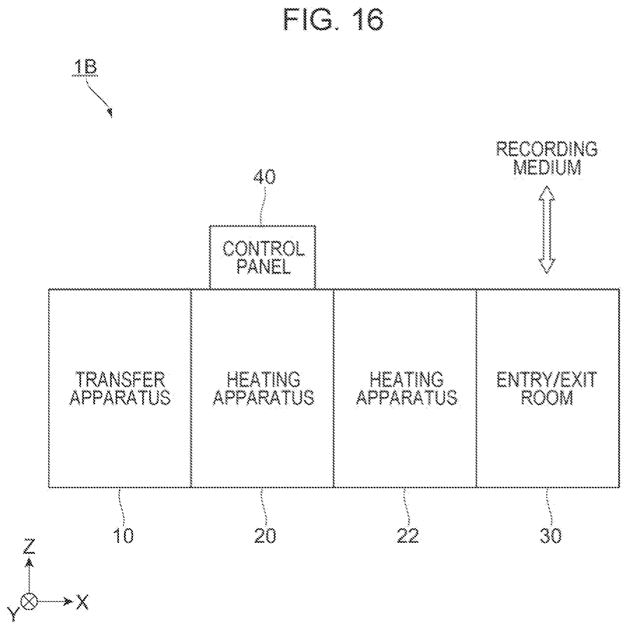

FIG. 16 illustrates the overall configuration of an image forming system 1B of the third exemplary embodiment. In FIG. 16, parts corresponding to those in FIG. 1 are represented by corresponding symbols.

In FIG. 16, the image forming system 1B includes a transfer apparatus 10 that transfers a toner image onto a recording medium M, heating apparatuses 20 and 22 that fix the transferred toner image onto the recording medium M, an entry/exit room 30, and a control panel 40.

The heating apparatus 20 is the same as the heating apparatus of the first exemplary embodiment. That is, the heating apparatus 20 fixes the toner image by the infrared method or the far-infrared method.

The heating apparatus 22 fixes the toner image onto the surface of the recording medium M by propagating heat at less than about 200° C.

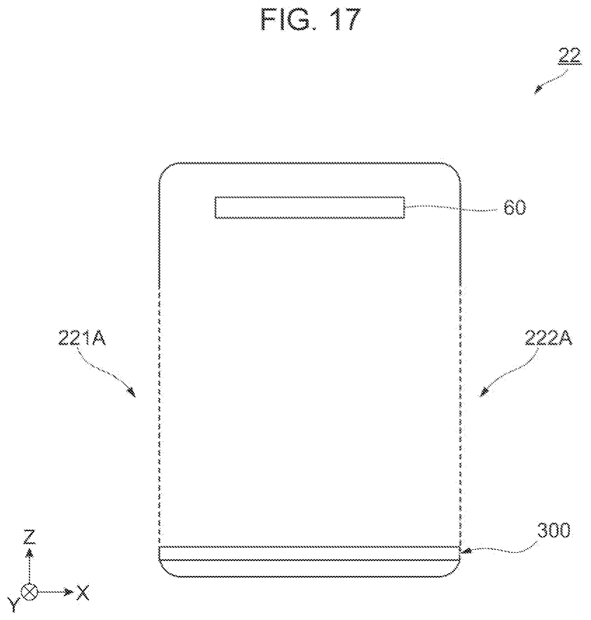

FIG. 17 illustrates an example of the configuration of the heating apparatus 22. In FIG. 17, parts corresponding to those in FIGS. 4A and 4B are represented by corresponding symbols.

The heating apparatus 22 has an opening 221A on the side for connection to the internal space of the heating apparatus 20, and has an opening 222A on the side for connection to the entry/exit room 30. A transport rail 300 is attached between the openings 221A and 222A.

This exemplary embodiment is different from the first exemplary embodiment in that the opening 202 of the heating apparatus 20 is connected to the internal space of the heating apparatus 22.

The heating apparatus 22 includes, in its upper space, a heating plate 60 having a heat source such as a heater. In this exemplary embodiment, this heating method is referred to as “oven method”. The heating plate 60 generates heat when oven heating is set to heat the recording medium M positioned in the internal space of the heating apparatus 22. The heating plate 60 is an example of the heat source.

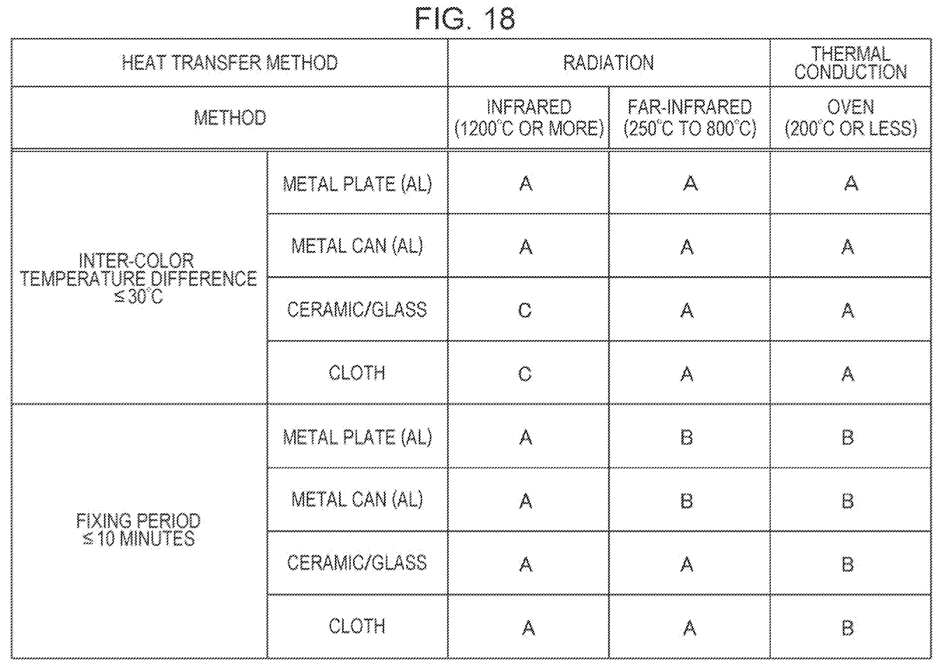

FIG. 18 is a table illustrating characteristics of infrared radiation, far-infrared radiation, and heat (i.e., oven). The characteristics of the infrared radiation and the far-infrared radiation are the same as those in the first exemplary embodiment, and description thereof is therefore omitted.

The temperature of the oven method is lower than that of far-infrared rays. Therefore, the inter-color temperature difference substantially does not occur. Thus, the evaluation result for each individual material is the highest evaluation level “A”. Although the evaluation result is the same as that of the far-infrared rays, the inter-color temperature difference is smaller in the case where the oven method is used for fixing the toner image.

The temperature of the oven method is lower than that of the far-infrared rays. Although the evaluation result of the fixing period is the same as that of the far-infrared rays, the fixing period is longer than in the case of the far-infrared rays. In this exemplary embodiment, the oven method is used for fixing the toner image onto a heat-sensitive cloth though the fixing period is long, and the same selection as in the first exemplary embodiment is made for the other materials.

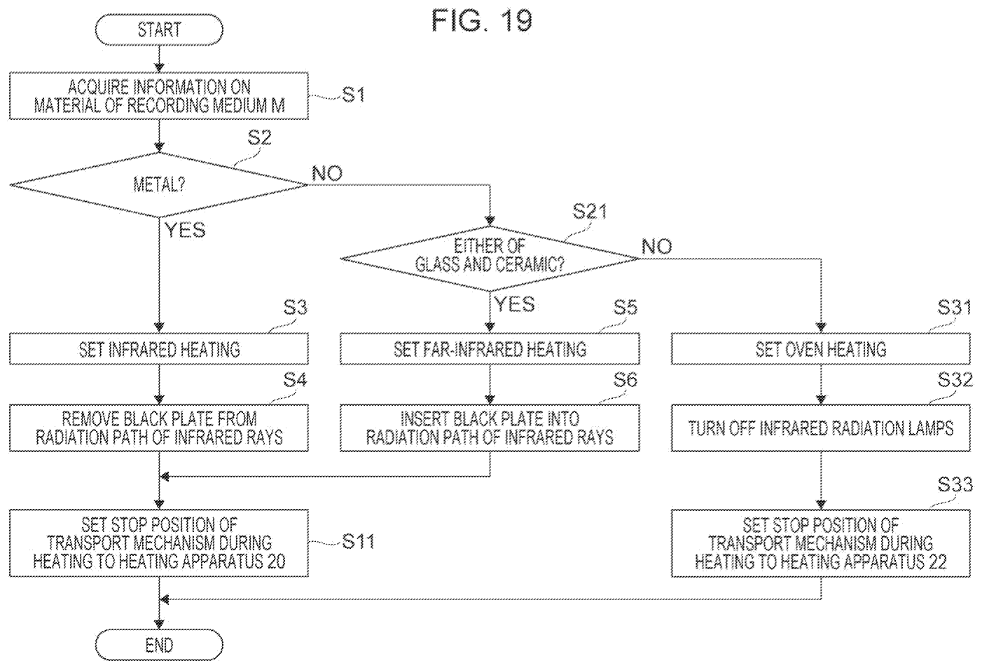

FIG. 19 is a flowchart illustrating another example of the fixing method switching control to be performed by the processor 401 (see FIG. 2). In FIG. 19, parts corresponding to those in FIG. 15 are represented by corresponding symbols.

The processor 401 acquires information on the material of the recording medium M (Step 1).

When the information on the material of the recording medium M is acquired, the processor 401 determines whether the material is metal (Step 2).

If the material is metal, the result is “YES” in Step 2. In this case, the processor 401 sets the infrared heating (Step 3) and removes the black plate 222 from the radiation path of infrared rays (Step 4).

The processor 401 sets the stop position of the transport mechanism 310 during the heating to the heating apparatus 20 (Step 11). This is because the two heating spaces are provided in this exemplary embodiment.

If the material is glass, ceramic, or cloth, the result is “NO” in Step 2. In this case, the processor 401 determines whether the material is “either of glass and ceramic” (Step 21).

If the material of the recording medium M is either of glass and ceramic, the result is “YES” in Step 21. In this case, the processor 401 sets the far-infrared heating (Step 5) and inserts the black plate 222 into the radiation path of infrared rays (Step 6). Then, the processor 401 sets the stop position of the transport mechanism 310 during the heating to the heating apparatus 20 (Step 11).

If the material is cloth, the result is “NO” in Step 21. In this case, the processor 401 sets the oven heating (Step 31). The processor 401 turns off the infrared radiation lamps 221 (see FIGS. 4A and 4B) (Step 32). Then, the processor 401 sets the stop position of the transport mechanism 310 during the heating to the heating apparatus 22 (Step 33).

### BRIEF SUMMARY

As described above, the image forming system 1B of this exemplary embodiment includes the heating apparatus 20 (see FIG. 16) configured to switch the two types of heating method, and the heating apparatus 22 (see FIG. 16) configured to perform the oven heating.

### Other Exemplary Embodiments

(1) Although the exemplary embodiments of the present disclosure have been described above, the technical scope disclosed herein is not limited to the scope described in the above exemplary embodiments. It is apparent that the technical scope disclosed herein includes various modifications or revisions of the above exemplary embodiments from the description of the claims.

(2) In the above exemplary embodiments, the entry/exit room 30 (see FIG. 1) has the opening on its top and the recording medium M enters and exits through the opening. The entry/exit room 30 may have the opening on its side.

(3) In the above exemplary embodiments, the transport mechanism 310 (see FIGS. 4A and 4B) is moved along the transport rail 300 (see FIGS. 4A and 4B). The transport mechanism 310 may be moved by a belt conveyor.

(4) In the above exemplary embodiments, the entry position and the exit position of the recording medium M are the same in the image forming system 1 (see FIG. 1) and the like. The entry position and the exit position may be different from each other.

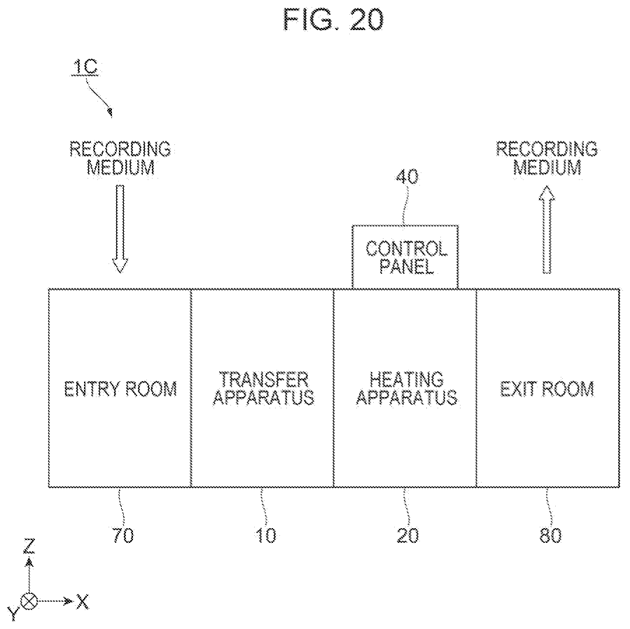

FIG. 20 illustrates the overall configuration of an image forming system 1C according to another exemplary embodiment. In FIG. 20, parts corresponding to those in FIG. 1 are represented by corresponding symbols. In FIG. 20, the image forming system 1C is based on the image forming system 1 of the first exemplary embodiment, but may be combined with the image forming system 1A of the second exemplary embodiment or the image forming system 1B of the third exemplary embodiment.

In the image forming system 1C illustrated in FIG. 20, an entry room 70 and an exit room 80 are used in place of the entry/exit room 30.

In the image forming system 1C illustrated in FIG. 20, the recording medium M that has entered the entry room 70 is transported to the adjacent transfer apparatus 10. The recording medium M onto which a toner image has been transferred by the transfer apparatus 10 is transport to the exit room 80 through the heating apparatus 20 and exits to the outside. In this case, the recording medium M is moved in one direction.

(5) In the above exemplary embodiments, the image forming system 1 (see FIG. 1) or the like is constituted by combining the heating apparatus 20 with the transfer apparatus 10 and the like. The heating apparatus 20, the heating apparatuses 20 and 21, or the heating apparatuses 20 and 22 may be used separately from the transfer apparatus 10.

(6) In the above exemplary embodiments, the hot air or the oven is used in the case where the material of the recording medium M is cloth. The hot air or the oven may be used for fixing the toner image onto glass or ceramic.

(7) In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A heating system comprising:
a heater compatible with a plurality of heating methods and configured to heat a heating target in a non-contact manner; and
one or more processors,
wherein the one or more processors are configured to switch a heating method to be used for heating the heating target depending on a material of the heating target.
   (((2)))

The heating system according to (((1))), wherein one of the plurality of heating methods is an infrared heating method.

(((3)))

The heating system according to (((1))) or (((2))), wherein the one or more processors are configured to:
select an infrared heating method if the material of the heating target is metal; and
select a far-infrared heating method if the material of the heating target is ceramic, glass, or cloth.
   (((4)))

The heating system according to any one of (((1))) to (((3))),
wherein the heater comprises an infrared light source, a black plate, and a drive mechanism configured to insert or remove the black plate, and
wherein the one or more processors are configured to:
   control the drive mechanism to remove the black plate from a radiation path of infrared rays in response to selection of an infrared heating method; and
   control the drive mechanism to insert the black plate into the radiation path of infrared rays in response to selection of a far-infrared heating method.
      (((5)))

The heating system according to (((1))) or (((2))), wherein the one or more processors are configured to:
select an infrared heating method if the material of the heating target is metal; and
select a hot air heating method or an oven heating method if the material of the heating target is cloth.
   (((6)))

An image forming system comprising:
a transport mechanism configured to transport a heating target;
a transfer apparatus configured to transfer a toner image onto the heating target; and
a heating system configured to heat the heating target onto which the toner image has been transferred,
wherein the heating system is the heating system according to any one of (((1))) to (((5))).

What is claimed is:

1. A heating system comprising:
a heater compatible with a plurality of heating methods and configured to heat a heating target in a non-contact manner; and
one or more processors,
wherein the one or more processors are configured to switch a heating method to be used for heating the heating target depending on a material of the heating target.

2. The heating system according to claim 1, wherein one of the plurality of heating methods is an infrared heating method.

3. The heating system according to claim 2, wherein the one or more processors are configured to:
select the infrared heating method if the material of the heating target is metal; and
select a far-infrared heating method if the material of the heating target is ceramic, glass, or cloth.

4. The heating system according to claim 3,
wherein the heater comprises an infrared light source, a black plate, and a drive mechanism configured to insert or remove the black plate, and
wherein the one or more processors are configured to:
control the drive mechanism to remove the black plate from a radiation path of infrared rays in response to selection of the infrared heating method; and
control the drive mechanism to insert the black plate into the radiation path of infrared rays in response to selection of the far-infrared heating method.

5. The heating system according to claim 2, wherein the one or more processors are configured to:
select the infrared heating method if the material of the heating target is metal; and
select a hot air heating method or an oven heating method if the material of the heating target is cloth.

6. An image forming system comprising:
a transport mechanism configured to transport a heating target;
a transfer apparatus configured to transfer a toner image onto the heating target; and
a heating system configured to heat the heating target onto which the toner image has been transferred,
wherein the heating system is the heating system according to claim 1.

7. An image forming system comprising:
a transport mechanism configured to transport a heating target;
a transfer apparatus configured to transfer a toner image onto the heating target; and
a heating system configured to heat the heating target onto which the toner image has been transferred,
wherein the heating system is the heating system according to claim 2.

8. An image forming system comprising:
a transport mechanism configured to transport a heating target;
a transfer apparatus configured to transfer a toner image onto the heating target; and
a heating system configured to heat the heating target onto which the toner image has been transferred,
wherein the heating system is the heating system according to claim 3.

9. An image forming system comprising:
a transport mechanism configured to transport a heating target;
a transfer apparatus configured to transfer a toner image onto the heating target; and
a heating system configured to heat the heating target onto which the toner image has been transferred,
wherein the heating system is the heating system according to claim 4.

10. An image forming system comprising:
a transport mechanism configured to transport a heating target;
a transfer apparatus configured to transfer a toner image onto the heating target; and
a heating system configured to heat the heating target onto which the toner image has been transferred,
wherein the heating system is the heating system according to claim 5.

11. A heating system comprising:
heating means for heating a heating target in a non-contact manner, the heating means being compatible with a plurality of heating methods; and
switching means for switching a heating method to be used for heating the heating target depending on a material of the heating target.
